(19) United States
(12) Patent Application Publication
(10) Pub. No.: US 2013/0177819 A1
(43) Pub. Date: Jul. 11, 2013

(54) RECHARGEABLE LITHIUM BATTERY

(71) Applicant: Su-Hee Han, Yongin-si (KR)

(72) Inventor: Su-Hee Han, Yongin-si (KR)

(73) Assignee: Samsung SDI Co., Ltd., Yongin-si (KR)

(21) Appl. No.: 13/616,586

(22) Filed: Sep. 14, 2012

(30) Foreign Application Priority Data
Jan. 9, 2012 (KR) 10-2012-0002635

(51) Int. Cl. H01M 10/056

(52) U.S. Cl. 429/303; 429/338

(57) ABSTRACT

A rechargeable lithium battery includes a negative electrode including a negative active material, a positive electrode including a positive active material, an electrolyte including a polymer, an additive having a borate structure, a lithium salt, and an organic solvent. The electrolyte includes about 0.1 wt % to about 10 wt % of the additive having a borate structure based on 100 wt % of the electrolyte. The organic solvent includes an acetate-based compound and a cyclic carbonate-based compound, and an amount of the acetate-based compound is larger than that of the cyclic carbonate-based compound.

### CLAIM OF PRIORITY

This application makes reference to, incorporates the same herein, and claims all benefits accruing under 35 U.S.C. §119 from an application earlier filed in the Korean Intellectual Property Office on the 9th of January 2012 and there duly assigned Serial No. 10-2012-0002635.

### BACKGROUND OF THE INVENTION

1. Field of the Invention

A rechargeable lithium battery is disclosed.

2. Description of the Related Art

Lithium rechargeable batteries have recently drawn attention as a power source of small portable electronic devices. They use an organic electrolyte solution and thereby have twice or more the discharge voltage than that of a conventional battery using an alkali aqueous solution, and accordingly have high energy density.

For positive active materials of a rechargeable lithium battery, lithium-transition element composite oxides being capable of intercalating lithium such as LiCoO₂, LiMn₂O₄, LiNi₁₋ₓCo₂O₂ (0<x<1), and so on have been used. For negative active materials of a rechargeable lithium battery, various carbon-based materials such as artificial graphite, natural graphite, and hard carbon, which can all intercalate and deintercalate lithium ions, have been used. However, recently there has been research into non-carbon-based negative active materials such as Si in accordance with need for stability and high-capacity.

### SUMMARY OF THE INVENTION

One embodiment of the present invention provides an improved rechargeable lithium battery.

One embodiment of the present invention provides a rechargeable lithium battery improving cycle-life capacity retention and reducing a thickness increase rate, as repeated cycles.

According to one embodiment of the present invention, provided is a rechargeable lithium battery that includes a negative electrode including a negative active material, a positive electrode including a positive active material, an electrolyte including a polymer, an additive having a borate structure, a lithium salt and an organic solvent. The electrolyte includes about 0.1 wt % to about 10 wt % of the additive having a borate structure based on 100 wt % of the electrolyte. The organic solvent includes an acetate-based compound and a cyclic carbonate-based compound, and an amount of the acetate-based compound is larger than that of the cyclic carbonate-based compound.

The acetate-based compound may be included in an amount of about 60 volume % to about 80 volume % based on 100 volume % of the organic solvent.

The cyclic carbonate may be included in an amount of about 20 volume % to about 40 volume % based on 100 volume % of the organic solvent.

The acetate-based compound may be one selected from the group consisting of methyl acetate, ethyl acetate, n-propyl acetate, dimethylacetate, methylpropionate, ethylpropionate, or a combination thereof.

The cyclic carbonate-based compound may comprise ethylene carbonate or ethylene carbonate derivatives.

The cyclic carbonate-based compound may further include propylene carbonate.

The additive having a borate structure may be LiB(C₂O₄)₂ (lithium bis(oxalato) borate; LiBOB).

The electrolyte may have viscosity of greater than or equal to about 4 cP before cross-linking.

The electrolyte may be a gel polymer electrolyte.

The lithium salt may be at least one lithium salt selected from the group consisting of LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers). LiCl, LiI, or a combination thereof.

The lithium salt may be included in a concentration of about 0.1M to about 2.0M.

The rechargeable lithium battery has improved capacity retention and remarkably reduced thickness expansion.

### BRIEF DESCRIPTION OF THE DRAWING

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic view of a rechargeable lithium battery according to one embodiment of the present invention.

### DETAILED DESCRIPTION OF THE INVENTION

Exemplary embodiments of the present invention will hereinafter be described in detail. However, these embodiments are only exemplary, and the present invention is not limited thereto.

The rechargeable lithium battery according to one embodiment of the present invention includes a negative electrode including a negative active material; a positive electrode including a positive active material; and an electrolyte including a polymer.

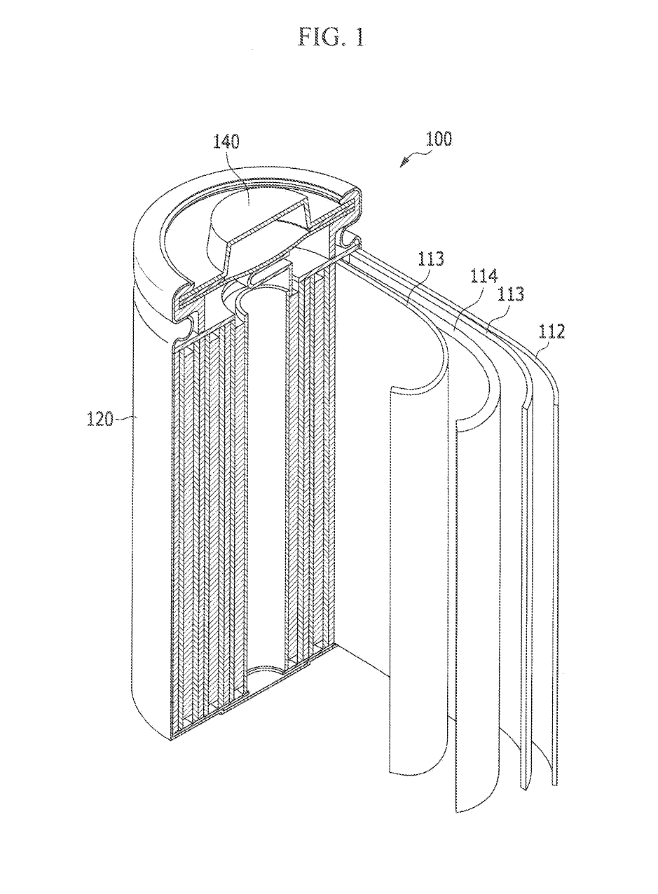

FIG. 1 is an exploded perspective view showing a rechargeable lithium battery according to one embodiment. Referring to FIG. 1, the rechargeable lithium battery 100 includes a negative electrode 112, a positive electrode 114, a separator 113 interposed between the negative electrode 112 and the positive electrode 114, an electrolyte (not shown) impregnating the negative electrode 112, positive electrode 114, and separator 113, a battery case 120, and a sealing member 140 sealing the battery case 120. The rechargeable lithium battery 100 is fabricated by sequentially laminating a negative electrode 112, a positive electrode 114, and a separator 113, spirally winding them, and housing the spiral-wound product in a battery case 120.

The electrolyte includes an additive having a borate structure and thereby improves ion conductivity. The additive having a borate structure may be LiB(C₂O₄)₂ (lithium bis(oxalato) borate; LiBOB).

The additive having a borate structure may be included in an amount of about 0.1 wt % to about 10 wt % based on 100 wt % of the electrolyte. When the additive having a borate structure is included in about 0.1 wt % to about 10 wt % based on 100 wt % of the electrolyte, the volume expansion is effectively improved to decrease the thickness increase rate of rechargeable lithium battery according to repeating the cycles.

The electrolyte include at least one lithium salt selected from LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, or a combination hereof, in addition to the additive having a borate structure.

The lithium salt is dissolved in an organic solvent that will be described and supplies lithium ions in a rechargeable lithium battery, and basically operates the rechargeable lithium battery and improves lithium ion transfer between positive and negative electrodes. The lithium salt may be used in a concentration of about 0.1 to about 2.0M. When the lithium salt is included within the above concentration range, it may provide electrolyte performance and lithium ion mobility due to optimal electrolyte conductivity and viscosity.

The electrolyte includes an acetate-based compound and a cyclic carbonate-based compound as an organic solvent that plays a role of transmitting ions taking part in the electrochemical reaction of a battery. The content of the acetate-based compound is greater than the content of the cyclic carbonate-based compound. The acetate-based compound has the low viscosity characteristics, so the electrode impregnation may be improved during the formation of the gel electrolyte including the polymer by using excessive amount of the acetate-based compound compared to the cyclic carbonate-based compound.

The mixing ratio of organic solvent may be adequately adjusted according to the purposed battery performance. For example, the acetate-based compound may be included in about 60 volume % to about 80 volume % based on 100 volume % of the organic solvent. The cyclic carbonate-based compound may be included in an amount of about 20 volume % to about 40 volume % based on 100 volume % of the organic solvent.

The acetate-based compound may include methyl acetate, ethyl acetate, n-propyl acetate, dimethylacetate, methylpropionate, ethylpropionate, and the like, which may be used in combination.

The cyclic carbonate-based compound may include ethylene carbonate (EC), ethylene carbonate derivatives, propylene carbonate (PC), butylene carbonate (BC), and the like, which may be used in combination. Particularly, for example, the cyclic carbonate-based compound may be ethylene carbonate (EC), ethylene carbonate derivatives; or a mixture of ethylene carbonate (EC) or ethylene carbonate derivatives, and propylene carbonate (PC).

The ethylene carbonate derivatives may be a compound represented by the following Chemical Formula 1.

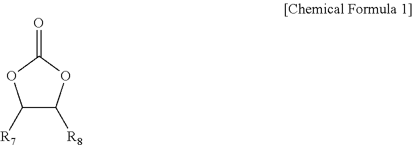

In Chemical Formula 1, R₇ and R₈ are each independently hydrogen, a halogen, a cyano group (CN), a nitro group (NO₂) or a C1 to C5 fluoroalkyl group, provided that at least one of R₇ and R₈ is a halogen, a cyano group (CN), a nitro group (NO₂) or a C1 to C5 fluoroalkyl group.

Examples of the ethylene carbonate derivatives include difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and the like. The use amount of the ethylene carbonate derivatives for improving cycle life may be adjusted within an appropriate range.

The organic solvent may further include a linear carbonate-based solvent, an ester-based solvent except the acetate-based solvent, an ether-based solvent, a ketone-based solvent, an alcohol-based solvent, or an aprotic solvent. The linear carbonate-based solvent include dimethyl carbonate (DMC), diethyl carbonate (DEC), dipropyl carbonate (DPC), methylpropyl carbonate (MPC) ethylpropyl carbonate (EPC), methylethyl carbonate (MEC), and the like, and the ester-based solvent except the acetate-based solvent may include γ-butyrolactone, decanolide, valerolactone, mevalonolactone, caprolactone, and the like. The ether-based solvent may include dibutyl ether, tetraglyme, diglyme, dimethoxyethane, 2-methyltetrahydrofuran, tetrahydrofuran, and the like, and the ketone-based solvent may include cyclohexanone, and the like. The alcohol-based solvent may include ethanol, isopropylalcohol, and the like. The aprotic solvent include nitriles such as R—CN (wherein R is a C2 to C20 linear, branched, or cyclic hydrocarbon group, and may include a double bond, an aromatic ring, or an ether bond), amides such as dimethylformamide, dimethylacetamide, dioxolanes such as 1,3-dioxolane, sulfolanes, and the like.

These additional organic solvent may be used singularly or in a mixture. When the organic solvent is used in a mixture, its mixture ratio can be controlled in accordance with desirable performance of a battery.

The organic solvent may further include an aromatic hydrocarbon-based organic solvent.

The aromatic hydrocarbon-based organic solvent may be an aromatic hydrocarbon-based compound represented by the following Chemical Formula 2.

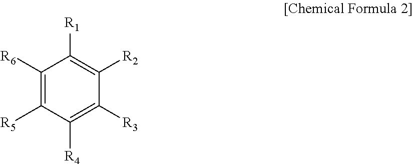

In Chemical Formula 2, R₁ to R₆ are each independently hydrogen, a halogen, a C1 to C10 alkyl group, a C1 to C10 haloalkyl group, or a combination thereof.

The aromatic hydrocarbon-based organic solvent may be benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-di chlorobenzene, 1,3-dichlorobenzene, 1,4-dichlorobenzene, 1,2,3-trichlorobenzene, 1,2,4-dichlorobenzene iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof.

In one embodiment, when the electrolyte further includes the above organic solvent in addition to the acetate-based compound and the cyclic carbonate-based compound, the amount of the above organic solvent may be 30 to 60 parts by volume based on 100 parts by total volume of the acetate-based compound and the cyclic carbonate-based compound.

The electrolyte may be a gel polymer electrolyte including a polymer. Such a gel polymer electrolyte may be obtained from polymerization within a battery. The gel polymer electrolyte may be prepared by adding a polymer-forming monomer and a polymerization initiator to an electrolyte including an organic solvent, an additive having a borate structure, and a lithium salt to prepare an electrolyte precursor solution, fabricating a battery using the solution, and allowing the battery to stand at a temperature at which polymerization starts for a predetermined number of hours. This gel polymer electrolyte refers to a chemical gel. The polymer-forming monomer may include acrylate, methacrylate, polyethyleneoxide (PEO), polypropyleneoxide (PPO), polyacrylonitrile (PAN), polyvinylidenefluoride (PVDF), polymethacrylate (PMA), polymethylmethacrylate (PMMA), diethylene glycol (DEG), ethylene glycol(EG), adipic acid-based monomer, trimethylolpropane, or a polymer thereof in addition, the monomer may include poly(ester)(meth)acrylate prepared by substituting a part or all of three-OH group of polyester)polyol with (meth)acrylic acid ester and substituting a group with no radical reactivity for the unsubstituted non-reacted —OH groups.

Examples of the polymer in the gel polymer electrolyte presented within the battery after forming the chemical gel, may include polyethyleneglycoldimethacrylate (PEGDMA), polyethyleneglycolacrylate, and the like. The examples of the gel polymer electrolyte are prepared by polymerizing a polymer through heating and appropriately selecting kinds and concentrations of the monomer, and controlling a temperature and time for polymerizing.

In order to prepare the gel polymer electrolyte from the aforementioned monomers, a polymerization initiator may be either organic peroxide or an azo-based compound or a mixture thereof.

The organic peroxide may include diacyl peroxides such as diacetyl peroxide, dibenzoyl peroxide, dilauroyl peroxide, bis-3,5,5-trimethyl hexanoyl peroxide, and the like; peroxy dicarbonates such as di(4-t-butylcyclohexyl)peroxy dicarbonate, di-2-ethylhexyl peroxy dicarbonate, diisopropyl peroxydicarbonate, di-3-methoxybutyl peroxy dicarbonate, t-butyl peroxy-isopropyl carbonate, t-butylperoxy-2-ethylhexyl carbonate, 1,6-bis(t-butyl peroxycarbonyloxy)hexane, diethyleneglycol-bis(t-butyl peroxy carbonate), and the like; and peroxyesters such as t-butyl peroxy pivalate, t-amyl peroxy pivalate, t-butyl peroxy-2-ethylhexanoate, t-hexyl peroxy pivalate, t-butyl peroxy neoheptanoate, t-hexyl peroxy pivalate, 1,1,3,3-tetramethylbutyl peroxy neodecarbonate, 1,1,3,3-tetramethylbutyl 2-ethylhexanoate, t-amylperoxy 2-ethylhexanoate, t-butyl peroxy isobutyrate, t-amylperoxy 3,5,5-trimethyl hexanoyl, t-butyl peroxy 3,5,5-trimethylhexanoate, t-butyl peroxy acetate, t-butyl peroxy benzoate, di-butylperoxy trimethyl adipate, and the like.

The composition for a polymer electrolyte may have viscosity of about greater than or equal to 4 centipoise (cP), for example, in a range of about 7 cP to about 16 cP.

The negative electrode includes a current collector and a negative active material layer formed on the current collector. The negative active material layer includes a negative active material.

The negative active material includes a material that reversibly intercalates/deintercalates lithium ions, a lithium metal, a lithium metal alloy, a material being capable of doping and dedoping lithium, or a transition metal oxide.

The material that reversibly intercalate/deintercalate lithium ions includes a carbon material. The carbon material may be any carbon-based negative active material generally used in a lithium ion rechargeable battery. Examples of the carbon material include crystalline carbon, amorphous carbon, and mixtures thereof. The crystalline carbon may be non-shaped, or sheet, flake, spherical, or fiber-shaped natural graphite or artificial graphite. The amorphous carbon may be a soft carbon, a hard carbon, a mesophase pitch carbonized product, fired coke, and the like.

Examples of the lithium metal alloy include lithium and a metal of Na, K, Rb, Cs, Fr, Be, Mg, Ca, Sr, Si, Sb, Pb, In, Zn, Ba, Ra, Ge, Al, or Sn.

The material being capable of doping and dedoping lithium may include Si, SiOₓ (0<x<2), a Si—C composite, a Si-Q alloy (wherein Q is an element selected from an alkali metal, an alkaline-earth metal, group 13 to 16 elements, transition elements, a rare earth element, or a combination thereof, and is not Si), Sn, SnO₂, a Sn—C composite, a Sn—R alloy (wherein R is an element selected from an alkali metal, an alkaline-earth metal, group 13 to 16 elements, a transition element, a rare earth element, or a combination thereof, and is not Sn), and the like. At least one of these may be used as a mixture with SiO₂. The elements Q and R may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide may include vanadium oxide, lithium vanadium oxide, and the like.

The negative active material layer also includes a hinder and optionally a conductive material.

The binder improves binding properties of the positive active material particles to one another and also, with a current collector. Examples of the binder include polyvinylalcohol, carboxylmethylcellulose, hydroxypropyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

The conductive material is included to improve electrode conductivity. Any electrically conductive material may be used as a conductive material, unless it causes a chemical change. Examples of the conductive material include carbon-based materials such as natural graphite, artificial graphite, carbon black, acetylene black, ketjen black, a carbon fiber, and the like; a metal-based material such as a metal powder or a metal fiber including copper, nickel, aluminum, silver, and the like; a conductive polymer such as a polyphenylene derivative, and the like; or mixtures thereof.

The current collector may be selected from the group consisting of a copper film, a nickel film, a stainless steel film, a titanium film, a nickel foam, a copper foam, a polymer substrate coated with a conductive metal, and a combination thereof.

The positive electrode may include a current collector and a positive active material layer disposed on the current collector.

The positive active material includes lithiated intercalation compounds that reversibly intercalate and deintercalate lithium ions. The positive active material may include a composite oxide including at least one selected from the group consisting of cobalt, manganese, and nickel, as well as lithium. Specific examples may be the compounds represented by the following chemical formulas:

LiₐA_{1-b}R_{b}D₂ (0.90≦a≦1.8 and 0≦b≦0.5); LiₐE_{1-b}R_{b}O_{2-c}D_{c} (0.90≦a≦1.8, 0≦b≦0.5 and 0≦c≦0.05); LiE_{2-b}R_{b}O_{4-c}D_{c} (0≦b≦0.5, 0≦c≦0.05); LiₐNi_{1-b-c}Co_{b}R_{c}D_{α} (0.90≦a≦1.8, 0≦b≦0.5, 0≦c≦0.05 and 0<α≦2); LiₐNi_{1-b-c}Co_{b}R_{c}O_{2-α}Z_{α} (0.90≦a≦1.8, 0≦b≦0.5, 0≦c≦0.05 and 0<α<2); LiₐₛNi_{1-b-c}Co_{b}R_{c}O_{2-α}Z₂ (0.90≦a≦1.8, 0≦b≦0.5, 0≦c≦0.05 and 0<α<2); LiₐNi_{1-b-c}Mn_{b}R_{c}D_{α} (0.90≦a≦1.8, 0≦b≦0.5, 0≦c≦0.05 and 0<α≦2); LiₐNi_{1-b-c}Mn_{b}R_{c}O_{2-α}Z_{α} (0.90≦a≦1.8, 0≦b≦0.5, 0≦c≦0.05 and 0<α<2); LiₐNi_{1-b-c}Mn_{b}R_{c}O_{2-α}Z₂ (0.90≦a≦1.8, 0≦b≦0.5, 0≦c≦0.05 and 0<α<2); LiₐNi_{b}E_{c}G_{d}O₂ (0.90≦a≦1.8, 0≦b≦0.9, 0≦c≦0.5 and 0.001≦e≦0.1); LiₐNi_{b}Co_{c}Mn_{d}GₑO₂ (0.90≦a≦1.8, 0≦b≦0.9, 0≦c≦0.5, 0≦d≦0.5 and 0.001≦e≦0.1); LiₐNiG_{b}O₂ (0.90≦a≦1.8 and 0.001≦b≦0.1); LiₐCoG_{b}O₂ (0.90≦a≦1.8 and 0.001≦b≦0.1); LiₐMnG_{b}O₂ (0.90≦a≦1.8 and 0.001≦b≦0.1); LiₐMn₂G_{b}O₄ (0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃ (0≦f≦2); Li_{(3-f)}Fe₂(PO₄)₃ (0≦f≦2); and LiFePO₄.

In the above Chemical Formulas, A is Ni, Co, Mn, or a combination thereof; R is Al, Ni, Co, Mn, Cr, Fe, Mg, Sr, V, a rare earth element, or a combination thereof; D is O, F, S, P, or a combination thereof; E is Co, Mn, or a combination thereof; Z is F, S, F, or a combination thereof; G is Al, Cr, Mn, Fe, Mg, La, Ce, Sr, V, or a combination thereof; Q is Ti, Mo, Mn, or a combination thereof; T is Cr, V, Fe, Sc, Y, or a combination thereof; and J is V, Cr, Mn, Co, Ni, Cu, or a combination thereof.

The positive active material may be a compound with a coating layer on the surface or a mixture of the active material and the compound with a coating layer thereon. The coating layer may include at least one coating element compound selected from the group consisting of an oxide of the coating element, a hydroxide of the coating element, an oxyhydroxide of the coating element, an oxycarbonate of the coating element, and a hydroxycarbonate of the coating element. The compound for the coating layer may be either amorphous or crystalline. The coating element included in the coating layer may be Mg, Al, Co, K, Na, Ca, Si, Ti, V, Sn, Ge, Ga, B, As, Zr, or a mixture thereof. The coating process may include any conventional processes unless it causes any side effects on the properties of the positive active material (e.g., spray coating, immersing), which is well known to those who have ordinary skill in this art and will not be illustrated in detail.

The positive active material layer further includes a binder and a conductive material.

The binder improves binding properties of the positive active material particles to one another and to a current collector. Examples of the binder include at least one selected from the group consisting of polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidenefluoride, polyethylene, polypropylene, styrene-butadiene rubber, acrylated styrene-butadiene rubber, an epoxy resin, nylon, and the like but are not limited thereto.

The conductive material improves electrical conductivity of a negative electrode. Any electrically conductive material can be used as a conductive agent unless it causes a chemical change. Examples of the conductive material include at least one selected from natural graphite, artificial graphite, carbon black, acetylene black, ketjen black, a carbon fiber, a metal powder or a metal fiber including copper, nickel, aluminum, silver, a polyphenylene derivative and the like.

The current collector may be Al but is not limited thereto.

The negative and positive electrodes may be fabricated in a method of preparing an active material composition by mixing the active material, a conductive material, and a binder and coating the composition on a current collector. The method of manufacturing an electrode is well known and thus, is not described in detail in the present specification. The solvent includes N-methylpyrrolidone and the like but is not limited thereto.

The separator 113 separates a negative electrode 112 and a positive electrode 114 and plays a role of a passage through which lithium ions move and may include any common separator used in a lithium battery. In other words, the separator may have low resistance against ion movement in an electrolyte and excellent moisturizing capability for the electrolyte solution. For example, the separator may be selected from glass fiber, polyester, TEFLON (tetrafluoroethylene), polyethylene, polypropylene, polytetrafluoroethylene (PTFE), or a combination thereof and may be a non-woven fabric or a cloth. For example, a lithium ion battery may include a polyolefin-based polymer separator such as polyethylene, polypropylene, and the like and a separator coated with a ceramic component or a polymer material to secure heat resistance or mechanical strength and may have selectively a single layer or multi-layers.

A rechargeable lithium battery may have a shape such as a cylinder, a prism, a coin, a pouch, and the like and may be classified into a bulk-type and a thin film type. The structure and the manufacturing method of these batteries are well known in a related field and will not be described in detail.

The rechargeable lithium battery is fabricated by inserting an electrode assembly including the positive and negative electrodes fabricated in a common method in a battery case, injecting a composition for a polymer electrolyte according to the present invention in the case, and curing it. The curing process may be well known in a related field and will not be illustrated in detail here. In the curing process, monomers included in a composition for a polymer electrolyte are polymerized into a polymer by a polymerization initiator. Accordingly, a polymer-type electrolyte is included in a battery. The battery case may be a metal can or a metal-laminated pouch.

The following examples illustrate the present invention in more detail. These examples, however, should not in any sense be interpreted as limiting the scope of the present invention.

### EXAMPLE

### Examples 1 to 5

A positive active material of lithium cobalt-based oxide (LiCoO₂) and a negative active material of graphite were prepared to provide electrodes. A film separator of polyethylene (PE) material was interposed between the electrodes to provide a battery cell. A electrolyte precursor solution was injected into a rechargeable lithium battery cell to provide a rechargeable lithium battery having a capacity of 330 mAh. As the electrolyte precursor solution, one included a mixed monomer of diethylene glycol, ethylene glycol, adipic acid-based monomer, trimethyolopropane, dibenzoyl peroxide photoinitiator, 1.3M LiPF₆ and an additive of LiB(ClO₄)₂ (lithium bis(oxalato) borate; LiBOB) and organic solvents at a composition shown in the following Table 1 was used. The amount of the dibenzoyl peroxide photoinitiator was about 2 wt % based on 100 wt % of the monomer. The resulting battery cell was allowed to stand at 45° C. for 1 hour, to prepare a chemical gel polymer electrolyte within the resulting battery cell.

### Comparative Examples 1 to 6

A rechargeable lithium battery cell was fabricated in accordance with the same procedure as in Examples, except that Comparative Example 1 used an electrolyte precursor solution including a mixed monomer of diethylene glycol, ethylene glycol, adipic acid-based monomer, trimethyolopropane, dibenzoyl peroxide photoinitiator, 1.3M LiPF₆ and organic solvents at a composition shown in the following Table 1, and Comparative Examples 2 to 6 included the compositions of LiBOB and organic solvents shown in the following Table 1.

The amount of the dibenzoyl peroxide photoinitiator was about 2 wt % based on 100 wt % of the monomer. The electrolyte solution included the following components. The viscosity of the electrolytes according to Examples 1 to 5 and Comparative Examples 1 to 6, were measured. The results are about 7 to 8 cp for the electrolytes according to Examples 1 to 5, and Comparative Examples 1 to 4, and about 12 cp for the electrolytes according to Comparative Examples 5 and 6.

EC: ethylene carbonate

PC: propylene carbonate

EP: ethyl propionate

EMC: ethylmethyl carbonate

DEC: diethyl carbonate

TABLE 1

| | | Additive | |
|---|---|---|---|
| | | (based on 100 wt % | Composition |
| | LiPF₆ | of electrolyte) | (volume ratio) |
| Example 1 | 1.3M | LiBOB 0.5 wt % | EC/PC/EP (3:1:6 vol %) |
| Example 2 | 1.3M | LiBOB 1 wt % | EC/PC/EP (3:1:6 vol %) |
| Example 3 | 1.3M | LiBOB 5 wt % | EC/PC/EP (3:1:6 vol %) |
| Example 4 | 1.3M | LiBOB 7 wt % | EC/PC/EP (3:1:6 vol %) |
| Example 5 | 1.3M | LiBOB 10 wt % | EC/PC/EP (3:1:6 vol %) |
| Comparative | 1.3M | LiBOB was | EC/PC/EP (3:1:6 vol %) |
| Example 1 | | not used | |
| Comparative | 1.3M | LiBOB 0.05 wt % | EC/PC/EP (3:1:6 vol %) |
| Example 2 | | | |
| Comparative | 1.3M | LiBOB 11 wt % | EC/PC/EP (3:1:6 vol %) |
| Example 3 | | | |
| Comparative | 1.3M | LiBOB 20 wt % | EC/PC/EP (3:1:6 vol %) |
| Example 4 | | | |
| Comparative | 1.3M | LiBOB 1 wt % | EC/EMC/DEC (3:3:4 vol %) |
| Example 5 | | | |
| Comparative | 1.3M | LiBOB 1 wt % | EC/EMC (3:7 vol %) |
| Example 6 | | | |

### Experimental Example 1

### Evaluation of Cycle-Life Capacity Retention

Each lithium ion battery cell obtained from Examples 1 to 5 and Comparative Examples 1 to 6 was charged and discharged at 1 C charge/1 C discharge for 1 cycle to calculate the capacity at 200 cycles to initial 1 cycle according to Equation 1, and the results are shown in the following Table

Cycle-life capacity retention(%)=(capacity after 200 cycles/capacity for 11 cycle)*100 [Equation 1]

### Experimental Example 2

### Evaluation of Cycle-Life Swelling Increase Rate

Each lithium ion battery cell obtained from Examples 1 to 5 and Comparative Examples 1 to 6 was charged and discharged at 1 C charge/1 C discharge for 1 cycle to calculate the battery thickness at 300 cycles to the initial 1 cycle according to the following Equation 2. The results are shown in the following Table 2. The battery thickness was determined by measuring the front part and the rear part of the battery by a Vernier calliper.

Thickness increase rate(%)=(thickness after 300 cycles thickness after 1 cycle)/thickness after 1 cycle)*100 [Equation 2]

TABLE 2

| | Cycle-life | Cycle |
|---|---|---|
| | capacity retention | thickness increase rate |
| | (after 200 cycles) | (after 300 cycles) |
| Example 1 | 78% | 11.3% |
| Example 2 | 82% | 9.5% |
| Example 3 | 81% | 13.4% |
| Example 4 | 80% | 14.9% |
| Example 5 | 80% | 15.4% |
| Comparative Example 1 | 65% | 20.1% |
| Comparative Example 2 | 67% | 18.7% |
| Comparative Example 3 | 79% | 19.6% |
| Comparative Example 4 | 73% | 22.1% |
| Comparative Example 5 | 68% | 19.8% |
| Comparative Example 6 | 64% | 22% |

From the results of Table 2, it is confirmed that the rechargeable lithium battery cells obtained from Examples including an appropriate amount of LiBOB in acetate-based and cyclic carbonate-based organic solvents had remarkably reduced the deteriorate of cycle-life capacity to maintain the high cycle-life capacity retention. In addition, it also confirmed that the cycle-life thickness increase rate was not high to provide a battery without the appearance deformation.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable lithium battery, comprising
a negative electrode including a negative active material;
a positive electrode including a positive active material;
an electrolyte including a polymer, an additive having a borate structure, a lithium salt, and an organic solvent,
the electrolyte comprises about 0.1 wt % to about 10 wt % of the additive having a borate structure based on 100 wt % of the electrolyte,
the organic solvent comprises an acetate-based compound and a cyclic carbonate-based compound, and an amount of the acetate-based compound is larger than that of the cyclic carbonate-based compound.

2. The rechargeable lithium battery of claim 1, wherein the acetate-based compound is included in an amount of about 60 volume % to about 80 volume % based on 100 volume % of the organic solvent.

3. The rechargeable lithium battery of claim 1, wherein the cyclic carbonate is included in an amount of about 20 volume % to about 40 volume % based on 100 volume % of the organic solvent.

4. The rechargeable lithium battery of claim 1, wherein the acetate-based compound is selected from the group consisting of methyl acetate, ethyl acetate, n-propyl acetate, dimethylacetate, methylpropionate, ethylpropionate, or a combination thereof.

5. The rechargeable lithium battery of claim 1, wherein the cyclic carbonate-based compound comprises ethylene carbonate or ethylene carbonate derivatives.

6. The rechargeable lithium battery of claim 5, wherein the cyclic carbonate-based compound further comprises propylene carbonate.

7. The rechargeable lithium battery of claim 1, wherein the lithium salt having a borate structure is LiB(C₂O₄)₂ (lithium bis(oxalato)borate; LiBOB).

8. The rechargeable lithium battery of claim 1, wherein the electrolyte has a viscosity of greater than or equal to about 4 cP before cross-linking.

9. The rechargeable lithium battery of claim 1, wherein the electrolyte is a gel polymer electrolyte.

10. The rechargeable lithium battery of claim 1, wherein the lithium salt comprises at least one selected from the group consisting of LiPF₆, LiBF₄, LiSbF₆, LiAsF₆, LiC₄F₉SO₃, LiClO₄, LiAlO₂, LiAlCl₄, LiN(CₓF₂ₓ₊₁SO₂)(C_{y}F_{2y+1}SO₂) (wherein, x and y are natural numbers), LiCl, LiI, or a combination thereof.

11. The rechargeable lithium battery of claim 10, wherein the lithium salt is included in a concentration of about 0.1 to about 2.0M.
